(19) United States
(12) Patent Application Publication
(10) Pub. No.: US 2023/0094578 A1
(43) Pub. Date: Mar. 30, 2023

(54) METHOD AND DEVICE FOR DETERMINING A DISTANCE IN AN ADDITIVE MANUFACTURING DEVICE

(71) Applicant: EOS GmbH Electro Optical Systems, Krailling (DE)

(72) Inventors: Ulrich Kleinhans, Prittriching (DE); Robert Achim Domroese, Germering (DE); Dominik Kunz, Gauting (DE)

(73) Assignee: EOS GmbH Electro Optical Systems, Krailling (DE)

(21) Appl. No.: 17/798,168

(22) PCT Filed: Feb. 16, 2021
(86) PCT No.: PCT/EP2021/053705

§ 371 Date: Aug. 8, 2022

(30) Foreign Application Priority Data
Feb. 24, 2020 (DE) 10 2020 202 353.0

(51) Int. Cl. B29C 64/393; B29C 64/153; B29C 64/214; B29C 64/218

(52) U.S. Cl. CPC B29C 64/393; B29C 64/153; B29C 64/214; B29C 64/218; B33Y 10/00

(57) ABSTRACT

A method for determining a distance in an additive manufacturing device includes emitting a number of directed beams using a number of beam sources, detecting at least one of the directed beams from a first beam source using a first detector and generating a signal in dependence on the at least one beam impinging on the least one detector, wherein a recoating element is spatially arranged between the first beam source and the first detector, and determining a distance between a boundary of the recoating element and a surface of a building base and/or an article placed on the building base, based on the signal generated by the detector and using an evaluation unit.

The present invention relates to a device and a method for additively producing a three-dimensional object by layer-wise application and selective solidification of a building material, preferably a powder, and in particular to a method and a device for determining a distance in such a device.

Devices and methods of this type are used, for example, in rapid prototyping, rapid tooling or additive manufacturing. An example of such a method is known as “selective laser sintering or laser melting”. In this method, a thin layer of a pulverulent building material is repeatedly applied and the building material in each layer is selectively solidified by selectively irradiating points that correspond to a cross-section of the object to be produced with a laser beam. Here, the application of a layer of the building material is generally carried out by moving a recoater across a working plane, wherein a recoating element, for example a recoater blade, of the recoater draws out building material in a build area to form a thin layer.

In order to make the application of a layer as reproducible as possible or to be able to apply layers with a uniform and predefined layer thickness, it is necessary, among other things, for the recoater or the recoating element to be at a predefined distance from the build area or from a plane in which the layer application is carried out. For this purpose, the recoater or recoating element and a building base on which the object is built must be adjusted relative to one another from time to time, in particular before the beginning of a building process. Such an adjustment process comprises a determination of the distance between the recoating element and the building base, as well as, if necessary, an adjustment, i.e. setting, of the distance.

The object of the present invention is to provide an alternative or improved method or an alternative or improved determination device for determining a distance in a device for producing a three-dimensional object by layer-wise selective solidification of a building material, wherein, in particular, a distance between a recoating element and a building base can be determined automatically.

This object is solved by a method for determining a distance according to claim 1, a computer program according to claim 7, a determination device according to claim 8, a manufacturing device according to claim 11 and a manufacturing method according to claim 15. Further developments of the invention are specified in the dependent claims, respectively. In this context, the methods can also be further developed by the features of the devices set forth below or in the dependent claims, or vice versa, or the features of the devices and of the methods each can also each be used among one another for further development.

A method according to the invention is used for distance determination in a device for producing a three-dimensional object by layer-wise selective solidification of a building material in a working plane on a building base, the device comprising at least a recoating element that can be moved in a recoating direction across the working plane for applying a layer of the building material. The method for determining a distance comprises at least the following steps:
emitting a number, preferably a plurality, of directed, preferably bundled, beams, specifically light beams, using a number of beam sources,
detecting at least one of the directed beams from a first beam source using a first detector and generating a signal in dependence on the at least one beam impinging on the at least one detector, the recoating element being spatially arranged between the first beam source and the first detector, and
determining a distance of a boundary of the recoating element facing the building base from the surface of the building base facing the recoating element and/or from an article placed on the building base, based on the signal generated by the detector and using an evaluation unit.

In the context of the present application, the term “beam” refers both to a beam bundle comprising a plurality of individual beams and to such an individual beam itself.

In the context of the application, directed beams are understood to be beams that have a defined path, i.e. are directed from a starting point to a defined target or in the direction of a defined target.

In general, a ray model of the radiation or light is used here to simplify the description, i.e. the propagation or path of the radiation or light is described in a simple, purely geometric manner on (imaginary) lines, to which a diameter is assigned if necessary, and which thus reproduce or represent the beam path of the individual beams. A beam is preferably defined by a propagation direction, i.e. its radiation path, and a geometric cross-section perpendicular to the propagation direction and/or an intensity and/or an intensity distribution, in particular with respect to the cross-sectional area of the beam, and/or a defined impact point or impact area in a (virtual or real) impact plane. Within the scope of this definition, a beam bundle preferably comprises a plurality of individual beams that have defined propagation directions and/or defined impact points with respect to each other. The individual beams of a beam bundle can run parallel to each other, i.e. have the same propagation direction, but they can also run divergently to each other, for example. Preferably, the impact points of the individual beams of a beam bundle form a single and spatially defined limited (i.e. with a defined geometric area) impact area in an impact plane.

Preferably, the beam is a laser beam or comprises several laser beams which is/are emitted by one or more laser sources. In general, a laser beam can have any beam geometry or geometry of the impact area, in particular a symmetrical geometry, for example substantially round, elliptical, square or diamond-shaped geometry, or also asymmetrical geometry. For example, a laser source can be a point laser that generates a laser beam with a substantially point-shaped impact area. Alternatively, the laser source can be, for example, a broad-area laser that generates a laser beam with an impact area that has a larger area than that of a point laser and has a predefined geometric shape. Alternatively, the laser source can be, for example, a line laser that generates a continuous line as an impact area. For example, the use of at least one line laser having an impact area extending in a vertical direction with respect to the recoating direction has been found to be practicable, whereby, for example, even tilting of the building platform in a direction perpendicular to the recoating direction can be detected. However, designs with an impact area of a line laser extending in a horizontal direction and perpendicular to the recoating direction have also proven suitable for distance determination.

The beam source can comprise, for example, one or more gas laser(s) and/or dye laser(s) and/or solid-state laser(s) and/or any other type of laser, such as laser diodes, in particular VCSEL (Vertical Cavity Surface Emitting Laser) or VECSEL (Vertical External Cavity Surface Emitting Laser) or edge-emitting laser diodes or a line of these laser types or several diodes, preferably with respective spectral filters.

Alternatively or in addition to a laser beam, a bundled beam can also be generated using a lamp whose light is imaged by a concave mirror or lens optics and passes through an aperture. A spectral filter can be used to achieve a desired spectrum of the light beam. For example, several photodiodes with spectral filters or apertures arranged in each case in the beam path and in front of the detector surface are suitable as detectors here.

Preferably, the beams are electromagnetic beams, in particular light beams, further preferably beams from the infrared and/or visible spectral range, or beams comprising this spectral range. However, other energy or particle beams emitted from a suitable beam source, e.g. electron beams, can also be used.

It should be noted that here and in the following the term “number” is always used in the sense of “one or more” and the term “plurality” is always used in the sense of “several”, i.e. at least two.

As mentioned above, the recoating element is spatially arranged between the beam source(s) and the detector(s). This means that at least one beam source with an output intensity is arranged on a first side of the recoating element and at least one detector is arranged on a second side of the recoating element opposite to the first side in the device. If there is a distance, for example in the form of a gap, between the boundary of the recoating element facing the building base and the building base and/or an article placed on the building base, at least part of the beam can pass between the recoating element and the building base along the propagation direction of the beam, which has a suitable cross-section. In doing so, the beam undergoes shadowing, i.e., it is partially clipped by the recoating element and/or the building base, so that the cross-sectional area of the beam is reduced and thus the intensity of the beam incident on the detector is lower than the initial intensity. This reduction in intensity, indicated by a corresponding detector signal, is a measure, or can be converted to a measure, of the distance between the recoating element and the building base or the article placed thereon, i.e., of the size of the gap.

Preferably, the geometric extension of a beam cross-section of the number of beams perpendicular to their propagation direction, in particular parallel to the distance to be determined, is greater than a distance to be determined between the boundary of the recoating element facing the building base and the surface of the building base facing the recoating element or the article placed on the building base. This makes it possible, for example, to determine the distance on the basis of a detector signal as a function of the shadowing of the at least one beam by the recoating element and/or the building base or the article placed thereon, in particular on the basis of a reduction in intensity.

Furthermore, the intensity of the beam or beams impinging on the detector and thus the detector signal can be generally dependent on the intensity distribution over the beam cross-section, i.e., a beam geometry of the beam or beams. The intensity distribution over the beam cross-section can be of any design. In particular, the beam geometry can correspond to a model profile, for example a Gaussian profile or a so-called top-hat profile, but it can also exhibit deviations from such an ideal profile and exhibit, for example, an imperfect Gaussian profile, an asymmetric beam profile, etc., or in general any beam profile.

In general, therefore, given a known intensity distribution or power density distribution of the beam or beams, the distance between the recoating element and the surface of the building base or of the article placed on the building base can be determined on the basis of an intensity reduction caused by the shadowing of the beam, starting from the signal generated by the detector. The intensity distribution of the number of beams can be known in advance, for example, in that the intensity distribution is determined in advance, e.g., by a detection in terms of measurement, or is available in advance from a data sheet, theoretical considerations, etc.

Preferably, the distance is determined on the basis of a predefined reference measurement curve, which is a strictly monotonic function that assigns a value of the distance to each signal generated by the detector. The reference measurement curve can, for example, be recorded in advance in terms of measurement, in particular in the manufacturing device itself, but it can also be derived or assumed, for example, from theoretical considerations or calculations, in particular if the intensity profile of the beam or beams is known. For example, if the intensity profile of the number of beams is known, an expected intensity reduction due to shadowing of the number of beams when they are clipped by the recoating element and/or the building base or the article placed thereon can be calculated as a function of the respective distance, and the corresponding expected detector signal can be assigned to the respective distance, and the function inverse thereto can be stored as a reference measurement curve. Alternatively, the reference measurement curve can be determined in advance, for example, from measurements outside the manufacturing device, e.g., in a laboratory, etc. The reference measurement curve can thus indicate a direct relationship between the detector signal and the respective distance, so that, for example, an actual intensity distribution over the beam cross-section does not necessarily have to be known in order to be able to conclude the corresponding distance from a respective detector signal. Preferably, the reference measurement curve is specifically determined for the respective beam(s) used in the method.

In one embodiment, a plurality of beam sources on a first side of the recoating element can be pointed to a single detector, in particular to the same area of a sensor surface of the detector, on the second side opposite the first side, preferably in a fan shape, wherein the beams emitted by the beam sources at least partially pass the recoating element successively, in particular not simultaneously, and a sequence of detector signals is output for determining the distance. In a further embodiment, a plurality of detectors on a first side of the recoating element can detect the beam or beams from a single beam source (e.g., a line laser), preferably in a fan shape, starting from the side opposite the first side, and output them as signals.

According to the method described above, the distance between the recoating element, or the boundary of the recoating element facing the building base, and the surface of the building base facing the recoating element can be determined. Alternatively or additionally, the distance between the recoating element, or the boundary of the recoating element facing the building base, and the article placed on the building base can be determined. Alternatively or additionally, a distance between the recoating element, or the boundary of the recoating element facing the building base, and the working plane can be determined in the method. The boundary of the recoating element facing the building base is preferably a lower side or lower edge of the recoating element. The article placed on the building base can be the manufactured object itself, but also an unevenness of the building base caused, for example, by production. Also, the article placed on the building base can be a residue or remainder of the object or of a support structure from a previous building process.

By means of the method for determining a distance in accordance with the invention, it is possible, for example, to carry out a distance determination between the building base or the article placed on the building base and the recoating element in a simple manner and, based on this, to correct a (vertical) position of the building platform and/or the recoating element, in particular to correct it automatically. Furthermore, by means of the method according to the invention, for example, a distance determination can be carried out with high accuracy, wherein the accuracy and/or reproducibility of the distance determination can be carried out with greater accuracy, in particular in comparison to a manual and/or contact-based distance determination, for example by means of a feeler gauge. By an improvement of a (measuring) accuracy is understood here in particular a reduction of a measuring error and in particular improvement of the reproducibility. The method for determining a distance according to the invention is a non-contact measurement method, which can further have the advantage that manual interventions in the device and, for example, an associated risk of contamination of the device can be avoided. The advantages of the method according to the invention described above may result in a reduction of the preparation time and/or post-processing time, especially due to the automation capability, of the additive manufacturing device. It is equally possible to carry out the above-described method for determining a distance during the additive manufacturing process, for example, if objects to be produced from the manufacturing process require high precision, i.e., depend on particularly uniformly drawn-out layers for sufficient functionality, for example.

Preferably, the detected signal comprises an electrical or digital signal, for example an electrical voltage or an electrical current or a y/n signal (yes/no signal) or a digital signal after conversion of an electrical signal. This allows, for example, a simple, in particular automatic, evaluation of the generated signal.

Preferably, the distance is determined in a comparison with a predefined reference system, in particular reference values, for example with reference measurement values, in particular a reference measurement curve recorded in advance. The reference system functions depending on and/or is based on the intensity distribution over the beam cross-section, i.e. in particular over the beam geometry, which defines the output intensity without shadowing by a boundary facing the building platform in the beam path onto the detector. Thus, for example, it is possible in a simple manner to determine from the generated signal, taking into account the beam geometry, the distance between the boundary of the recoating element facing the building base and the surface of the building base facing the recoating element and/or the article placed on the building base.

Preferably, the method further comprises a step of a position adjustment and/or orientation adjustment of the recoating element and/or of the building base. The position and/or alignment adjustment may comprise, for example, a height adjustment, i.e. an adjustment perpendicular to the working plane, and/or a tilting of the recoating element and/or of the building base. This makes it possible, for example, to adjust the building base and/or the recoating element, in particular with the aid of the working plane and/or the building base, relative to one another and/or absolutely, i.e. with respect to their predefined position in the device, for example with the aid of a reference edge as an absolute height determined from the relative positioning step.

Preferably, in the method, the building base is moved from an initial position in the direction of the recoating element, and meanwhile the at least one signal is detected continuously or stepwise in the evaluation unit. By continuously or stepwise detecting the at least one signal, a (temporal) change of the signal is thus detected and thus also the distance in a certain measuring range is determined continuously or stepwise. This makes it possible, for example, to carry out a continuous or stepwise distance measurement and/or to bring the building base and/or the recoating element into a position in which they are at a predefined distance from one another.

Preferably, the distance is determined at a first location with respect to a longitudinal extension of the recoating element using the first beam source and the first detector and additionally at at least one second location with respect to the longitudinal extension of the recoating element using at least one second beam source and/or at least one second detector, the first and second locations being different from one another. The term “longitudinal extension” of the recoating element designates its main extension direction, wherein the longitudinal extension or longitudinal direction extends in particular transverse, preferably perpendicular, to the recoating direction. The first and second locations, as well as any further locations, are thus spaced apart from one another, in particular spaced apart from one another in the longitudinal direction of the recoating element and/or transverse to the recoating direction. This makes it possible, for example, to detect unevenness of the building base and/or of the boundary of the recoating element facing the building base and/or to detect tilting of the building base relative to the recoating element and/or tilting of the recoating element relative to the building base, for example perpendicular to the recoating direction.

Alternatively or in addition to a determination of the distance at at least two different locations along the longitudinal extension of the recoating element, the distance is preferably determined at each of a first location with respect to the travelling position of the recoating element along the recoating direction and at least one second location with respect to the travelling position of the recoating element along the recoating direction, the first and second locations being different from one another. Preferably, therefore, the distance is determined in each case at a first travelling position of the recoating element and at at least one second travelling position of the recoating element that is different from or spaced apart from the first travelling position, the first and second travelling positions being spaced apart from one another at least in the recoating direction. Thus, between a first distance determination (at the first travelling position) and a second distance determination (at the second travelling position), the recoating element or the recoater on which the recoating element is provided is moved in the recoating direction. The distance determinations can also be carried out continuously or step-wise while the recoater or the recoating element is being moved in the recoating direction, in particular also at more than two locations spaced apart from one another.

By detecting the distance at two spaced-apart travelling positions of the recoating element, it is possible, for example, to detect unevenness of the building base and/or to detect tilting of the building base relative to the recoating element.

Preferably, in the method, alternatively or in addition to determining a distance, a tilting of the building platform in a direction perpendicular to the recoating direction and/or a tilting of the recoating element relative to the building base, for example perpendicular to the recoating direction, is detected.

A computer program according to the invention comprises program code means for carrying out all steps of a method for determining a distance described above when the computer program is executed by means of a data processor, in particular a data processor cooperating with a device for producing a three-dimensional object by layer-wise selective solidification of a building material. With such a computer program it is possible, for example, to carry out the method for determining a distance described above completely automatically or at least partially automatically.

A determination device according to the invention serves for determining a distance in a device for producing a three-dimensional object by layer-wise selective solidification of a building material in a working plane on a building base, the device comprising at least a recoating element that can be moved in a recoating direction across the working plane for applying a layer of the building material. The determination device at least comprises:
a number of beam sources, adapted to emit a number, preferably a plurality, of directed, preferably bundled, beams, specifically light beams,
at least one first detector for detecting at least one of the directed beams from a first beam source and generating a signal depending on the beam impinging on the first detector,
an evaluation unit which, in operation, determines a distance between a boundary of the recoating element facing the building base and the surface of the building base facing the recoating element and/or an article placed on the building base, based on the signal generated by the detector, when the recoating element is spatially arranged between the first beam source and the first detector.

With such a determination device, it is possible, for example, to equip or retrofit a device for producing a three-dimensional object by layer-wise selective solidification of a building material, so that a method for determining a distance described above can be performed in the device.

Preferably, the detector comprises a number of photodiodes and/or is designed as a CCD sensor and/or as a CMOS sensor. Thus, for example, various sensors are provided as a detector with which a signal can be generated in a simple manner based on the intensity of the radiation impinging on the detector. Depending on the implementation of the beam source, temperature sensors are also suitable as detectors, e.g. in the form of thermocouples, PT-100 sensors or an atomic layer sensor.

Preferably, the beam source comprises a light source, further preferably a laser, the laser light of which is preferably in the visible and/or infrared wavelength range. A light source has, for example, the advantage of being a low-cost and/or easy-to-use beam source. A laser beam has, for example, the advantage that it has defined, in particular physical, properties, such as sharp bundling, high intensity, and possibly a narrow frequency range (in the case of a monochromatic laser beam), which can increase the accuracy of the distance measurement, for example. By providing a laser beam in the visible wavelength range, for example, the positioning of the laser and/or of the detector in the device or the alignment of the laser and the detector relative to each other can be simplified.

Preferably, the beam(s) is/are a light beam(s) and at least one spectral filter is positioned in the propagation direction of the beam(s). The spectral filter can in particular be positioned at a distance from the detector and/or in a housing compound with the detector. Further preferably, the distance of the spectral filter from the detector or housing compound is at most 30 mm, further preferably at most 10 mm, even further preferably at most 5 mm, particularly preferably at most 2 mm. Alternatively or additionally, the spectral filter can be integrally formed with the beam source or can be arranged in the beam path behind the beam source, for example at a distance of at most 30 mm, further preferably at most 10 mm, still further preferably at most 5 mm, particularly preferably at most 2 mm from the beam source. In this context, a spectral filter is understood to be an optical filter which blocks out or transmits a part of the light spectrum. This makes it possible, for example, to restrict interfering radiation, in particular ambient light, and thus to improve distance measurement.

A device according to the invention serves to produce a three-dimensional object by layer-wise selective solidification of a building material in a working plane on a building base. The device comprises at least a recoating element movable in a recoating direction across the working plane for applying a layer of the building material, a number of beam sources adapted to emit a number, preferably a plurality, of directed, preferably bundled, beams, specifically light beams, at least one first detector for detecting at least one of the directed beams from a first beam source and generating a signal depending on the beam impinging on the first detector, wherein the recoating element is spatially arranged between the first beam source and the first detector. Further, the device comprises an evaluation unit which, in operation, determines a distance of a boundary of the recoating element facing the building base from the surface of the building base facing the recoating element and/or from an article placed on the building base, based on the signal generated by the detector. With such a device, it is possible, for example, to achieve the effects described above with respect to the method for determining a distance also with an additive manufacturing device.

Preferably, the beam source is arranged in the device in such a way that a propagation direction of the directed beam is substantially parallel to the working plane and/or substantially parallel to the recoating direction. Alternatively or additionally, the beam source is preferably arranged in the device in such a way that the directed beam is partially shadowed by the recoating element and/or by the building base and/or by the article placed on the building base. This can improve the determination of the distance, for example.

Preferably, the device and/or the determination device further comprises a control unit adapted to control the device such that it executes or performs a method for determining a distance described above.

Preferably, the at least one beam source and/or the at least one detector are provided fixedly in the device, in particular a process chamber of the device, i.e. provided integrally therewith. This makes it possible, for example, to perform the distance measurement described above as required and at any required time without having to insert the beam source and/or the detector into the device or its process chamber prior to the distance measurement.

Alternatively or additionally, the at least one beam source and/or the at least one detector can be provided separately from the device and can be attachable to the device and/or in the process chamber by means of suitable elements for, preferably detachably, attaching the beam source and/or the detector, e.g. by means of a screw connection, magnetic attachment, or the like. This makes it possible, for example, to provide the beam source and/or the detector as an equipment and/or retrofit kit with which an additive manufacturing device can be easily equipped or retrofitted.

Preferably, the recoating element is provided on a recoater of the device. Preferably, the recoating element is designed as a spreader element, preferably as a dimensionally stable spreader element, for example as a blade and/or as a recoating roller. Alternatively, the recoating element can be designed as a flexible spreader element, for example as a rubber lip and/or brush. In particular when using dimensionally stable spreader elements, i.e. a blade or roller, as a recoating element, the invention can be advantageous over other methods, in particular contact-based measuring methods.

A method according to the invention for producing a three-dimensional object on a building base comprises the steps:
applying a layer of a building material using at least one recoating element that can be moved in a recoating direction across a working plane,
selectively solidifying the applied layer of the building material at points that correspond to the cross-section of the three-dimensional object in the respective layer, and
repeating the steps of applying and selectively solidifying until the three-dimensional object is completed, and
carrying out a method for determining a distance described above.

The method for determining a distance can be inserted into the process steps of the manufacturing process at any time, preferably it is carried out before the start of the initial application of a layer of the building material and/or after a restart of the device. This makes it possible, for example, to set the thickness of a building material layer to be applied as precisely as possible to a defined value and thus to improve the dimensional accuracy and quality of the object to be manufactured.

Further features and expediencies of the invention will be apparent from the description of exemplary embodiments with reference to the attached drawings.

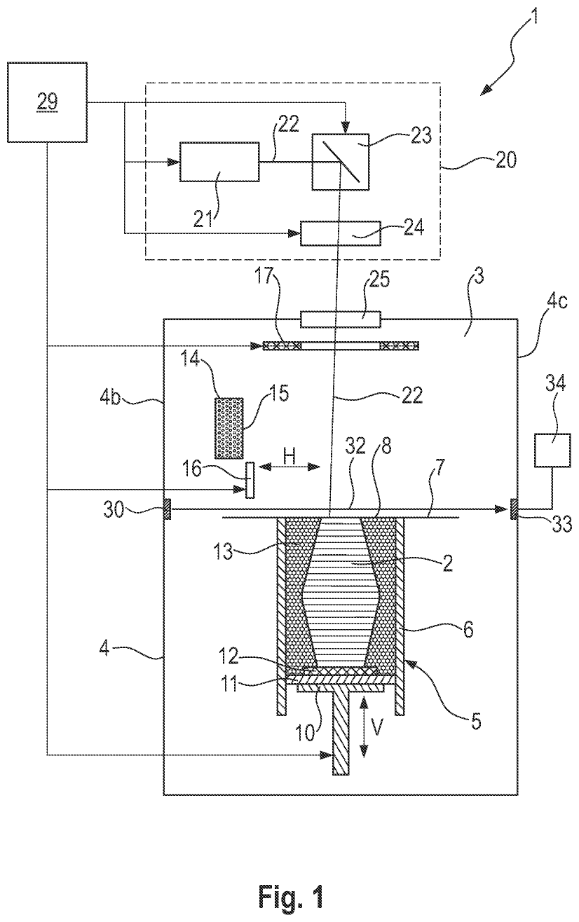

FIG. 1 shows a schematic view, partially in cross-section, of a device for the additive production of a three-dimensional object according to an embodiment of the present invention,

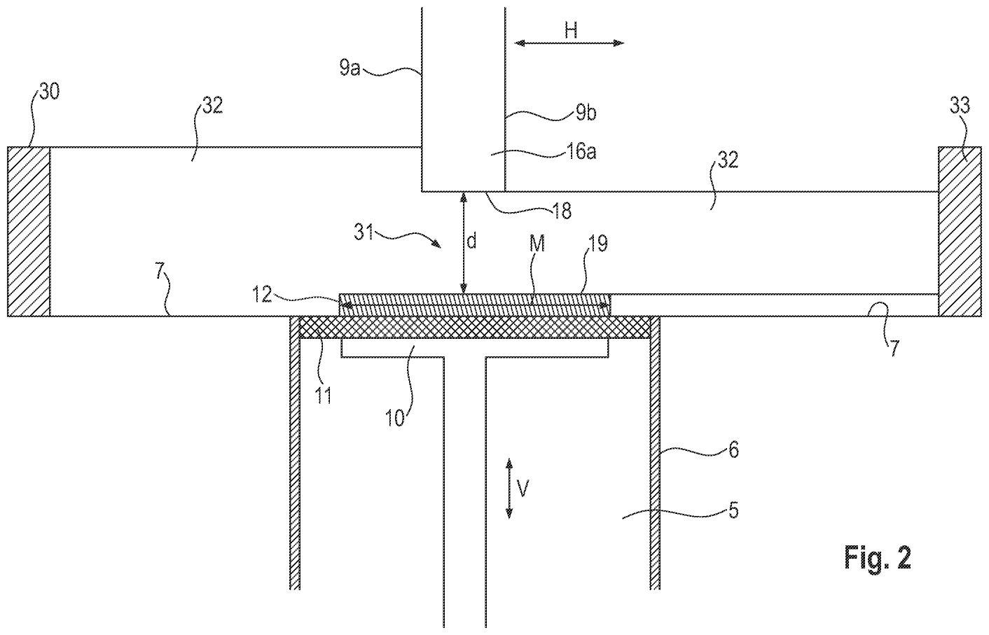

FIG. 2 shows a schematic view of a portion of the device shown in FIG. 1 in cross-section,

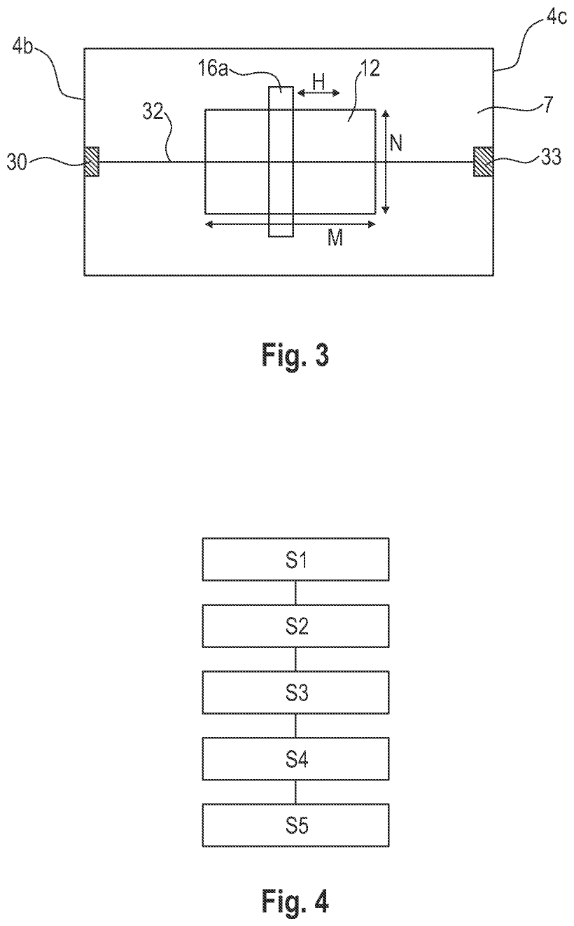

FIG. 3 shows a schematic top view of the working plane of the device shown in FIGS. 1 and 2 from above,

FIG. 4 is a schematic block diagram schematically showing a method for determining a distance in the device shown in FIGS. 1 to 3,

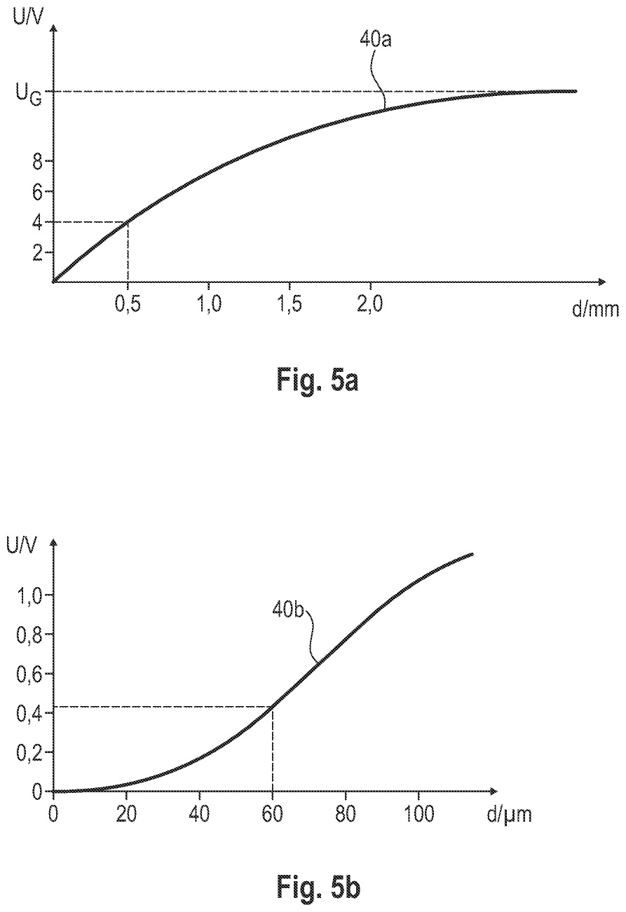

FIGS. 5a and 5b each show an exemplary reference measurement curve for carrying out a distance determination, and

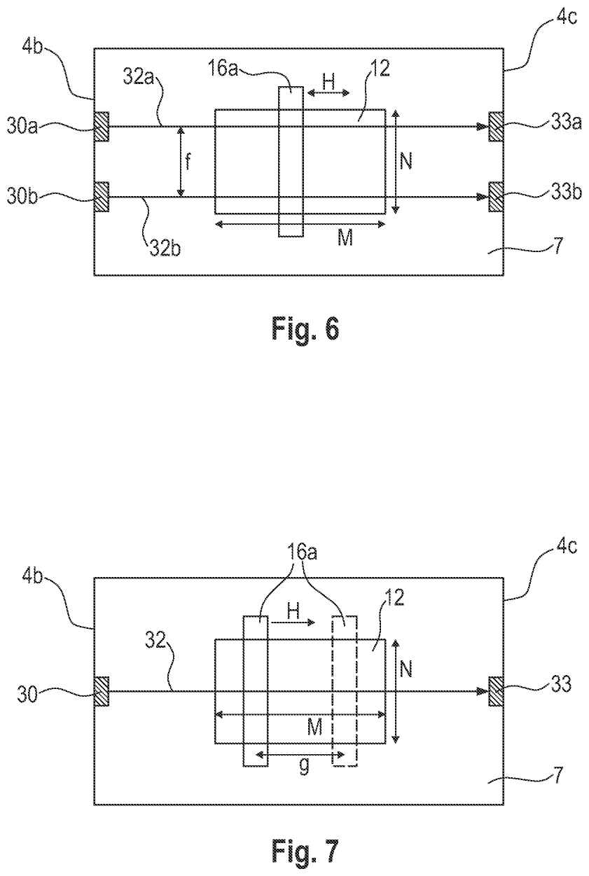

FIGS. 6 and 7 are schematic top views of the working plane from above according to further developments of the present invention.

In the following a first embodiment of the present invention is described with reference to FIG. 1, FIG. 2 and FIG. 3. The device shown in FIG. 1 is a laser sintering or laser melting device 1. For building an object 2, it contains a process chamber 3 having a chamber wall 4.

A container 5 open to the top and having a container wall 6 is arranged in the process chamber 3. A working plane 7 is defined by the upper opening of the container 5, wherein the area of the working plane 7 located within the opening, which can be used for building up the object 2, is referred to as the build area 8.

A support 10 movable in a vertical direction V is arranged in the container 5, to which a base plate 11 is attached which closes the container 5 to the bottom and thus forms the bottom thereof. The base plate 11 can be a plate formed separately from the support 10 and attached to the support 10, or it can be formed integrally with the support 10. Depending on the powder and process used, a building platform 12 can further be attached to the base plate 11 as a building base on which the object 2 is built. However, the object 2 can also be built up on the base plate 11 itself, which then serves as a building base. In FIG. 1, the object 2 to be formed in the container 5 on the building platform 12 is shown below the working plane 7 in an intermediate state with several solidified layers surrounded by building material 13 that has remained unsolidified.

The laser sintering or laser melting device 1 further comprises a storage container 14 for a building material 15 in powder form that can be solidified by electromagnetic radiation and a recoater 16 movable in a horizontal direction H, which is hereinafter also referred to as the recoating direction, for applying the building material 15 within the build area 8. Preferably, the recoater 16 extends transversely to its direction of movement over the entire area to be coated. The recoater 16 comprises at least one recoating element designed as a recoater blade 16a (see FIG. 2).

Optionally, a radiation heater 17 is arranged in the process chamber 3, which serves to heat the applied building material 15. For example, an infrared radiator can be provided as the radiation heater 17.

In a first side 4b of the chamber wall 4, a beam source in the form of a laser 30 is provided, which generates a laser beam 32 during operation. In a second side 4c of the chamber wall 4, which is preferably opposite the first side 4b, a detector 33 is arranged for detecting the laser beam 32 generated by the laser 30. The laser 30 is preferably configured to generate laser light having a wavelength in the visible and/or infrared wavelength range. The detector 33 preferably comprises a number of photodiodes and/or is designed as a CCD sensor and/or as a CMOS sensor. The detector 33 can be configured to generate a signal as a function of the laser light incident on the detector 33, for example an electrical or digital signal, such as an electrical voltage or an electrical current or a y/n signal. Alternatively, the detector 33 can be part of a detection unit (not shown in the figures) which is adapted to generate such a signal as a function of the laser light impinging on the detector 33.

The laser 30 and the detector 33 do not have to be provided in the chamber wall 4; they can, for example, also be set off from the chamber wall 4 and, for example, extend into the interior of the process chamber 3 or be provided in the interior of the process chamber 3.

Via a data connection not shown in FIG. 1, for example a data cable, the detector 33 or the detection unit (not shown in the figures) is connected to an evaluation unit 34, that is configured to evaluate the signal generated by the detector 33 or the detection unit. The evaluation unit 34 can be arranged outside the process chamber 3, as shown in FIG. 1. Alternatively, the evaluation unit 3 can also be arranged inside the process chamber 3.

The laser sintering or laser melting device 1 further includes an exposure device 20 having a solidification laser 21 that generates a solidification laser beam 22, which is deflected by a deflection device 23 and focused onto the working plane 7 by a focusing device 24 via a coupling window 25 provided on the upper side of the process chamber 3 in the chamber wall 4.

Further, the laser sintering or laser melting device 1 includes a control unit 29 via which the individual components of the device 1 are controlled in a coordinated manner to implement the building process. Alternatively, the control unit 29 can be provided partially or entirely external of the device 1. The control unit 29 can include a CPU whose operation is controlled by a computer program (software). The computer program can be stored separately from the device 1 on a storage medium from which it can be loaded into the device 1, in particular into the control unit 29.

In operation of the laser sintering or laser melting device 1, in order to apply a powder layer, the support 10 is first lowered by an amount that corresponds to the desired layer thickness. The recoater 16 first moves to the storage container 14 and therefrom receives an amount of the building material 15 sufficient to apply a layer. Then it moves across the build area 8, applies building material 15 in powder form there onto the building base and/or a powder layer already present, and draws it out to form a powder layer. The application is carried out at least over the entire cross-section of the object 2 to be produced, preferably over the entire build area 8, i.e. the area bounded by the container wall 6. Optionally, the pulverulent building material 15 is heated to a working temperature by means of a radiation heater 17.

Subsequently, the cross-section of the object 2 to be produced is scanned by the solidification laser beam 22 so that the pulverulent building material 15 is solidified at the points that correspond to the cross-section of the object 2 to be produced. In this process, the powder grains are partially or completely melted at these points by means of the energy introduced by the radiation, so that they are present joined together as a solid body after cooling. These steps are repeated until the object 2 is finished and can be removed from the process chamber 3.

The arrangement of the laser 30 and the detector 33 in the laser sintering or laser melting device 1 are described in more detail below with reference to FIG. 2 and FIG. 3. Here, FIG. 2 shows a schematic view of the arrangement from the side, i.e., in a cross-sectional plane perpendicular to the working plane 7 and parallel to the recoating direction H. FIG. 3 shows a top view of a region of the working plane 7 from above with a rectangular building platform 12, which has a length M in the recoating direction H and a width N perpendicular to the recoating direction H.

In FIG. 2, the building platform 12 is moved out of the container 5 so that its surface 19 that faces the recoater blade 16a is located above the working plane 7. The recoater blade 16a has a boundary of the recoater blade 16a facing downward, i.e. toward the surface 19 of the building platform 12, and formed as a recoating face 18. In FIG. 2, the recoating face 18 is spaced apart from the surface 19 of the building platform 12 by an amount d, i.e., by the distance d, so that a gap 31 is formed between the recoater blade 16a and the building platform 12. The recoater blade 16a has an elongate shape, i.e., it extends in a longitudinal direction (into the drawing plane in FIG. 2), which is the main extension direction of the recoater blade 16a, and is arranged in the process chamber such that the longitudinal direction of the recoater blade 16a is parallel to the width N of the building platform 12, i.e., perpendicular to the recoating direction H (see FIG. 3).

The laser 30 and the detector 33 are each provided in an area of the process chamber 3 outside the build area 8, i.e., outside the area of the building platform 12. The laser 30 and the detector 33 are arranged such that the laser beam 32 is directed onto the detector 33. Preferably, as shown in FIGS. 2 and 3, the laser 30 is arranged in the process chamber 3 in such a way that the propagation direction of the laser beam 32 is parallel to the recoating direction H, i.e. parallel to the length M of the building platform 12, and parallel to the working plane 7.

Preferably, a spectral filter not shown in the figures is positioned in the propagation direction of the laser beam 32, in particular at a distance, for example at a distance of at most 10 mm, from the detector 33 and/or in a housing compound with the detector 33. This spectral filter can in particular be adapted to the wavelength or wavelength range of the laser light emitted by the laser 30, so that it substantially allows only the light spectrum generated by the laser 30 to pass.

The recoater blade 16a is spatially arranged between the laser 30 and the detector 33, i.e., the laser 30 faces a first side 9a of the recoater blade 16a and the detector 33 faces a second side 9b of the recoater blade 16a opposite the first side 9a. Thus, when the recoater blade 16a is spaced apart from the building platform 12 by the distance d as shown in FIG. 2, the laser beam 32 generated by the laser 30 passes at least partially between the recoater blade 16a and the building platform 12, i.e., through the gap 31, and impinges on the detector 33. In other words, the laser beam 32 is thus partially clipped by the recoater blade 16a when it is spaced from the building platform 12. Obviously, above a certain limiting distance (not shown in FIG. 2), the laser beam 32 is no longer clipped by the recoater blade. Preferably, as shown in FIG. 2, the laser 30 is further arranged in the process chamber 3 such that the laser beam 32 is partially clipped by the building platform 12. Thus, in FIG. 2, a first portion of the laser beam 32, i.e., a first part of its cross-sectional area, impinges on the recoater blade 16a and a second portion of the laser beam 32, i.e., a second part of its cross-sectional area, passes through the gap 31 between the recoater blade 16a and the building platform 12 and impinges on the detector 33, and a third portion of the laser beam 32, i.e., a third part of its cross-sectional area, impinges on the building platform 12.

Referring to FIG. 4, a method for determining the distance d between the surface 19 of the building platform 12 and the recoating face 18 of the recoater blade 16a is described in the following.

In the first step S1, the laser beam 32 is generated or emitted by the laser 30. At least a portion of the laser beam 32 passes through the gap 31 between the surface 19 of the building platform 12 and the recoating face 18 of the recoater blade 16a, as described above, and impinges on the detector 33. In the second step S2, the detector 33 detects the portion of the laser beam 32 impinging thereon, and in the third step S3, the detector 33 or the detection unit not shown generates a signal depending on the laser beam impinging on the detector 33. Preferably, the signal depends on the intensity of the laser light incident on the detector 33, that is, the greater the intensity of the laser light incident on the detector 33, the greater a characteristic value, for example, a signal level of the signal. For example, the signal can be an electrical voltage that is greater the greater the intensity of the laser light incident on the detector 33. Alternatively, the signal can be an electrical current which is greater the greater the intensity of the laser light incident on the detector 33 and that can be represented, for example, by conversion to a digital signal. Preferably, the characteristic value, for example the electrical voltage or current, has a linear relationship with the intensity of the laser light impinging on the detector 33 or a linearized relationship, wherein the linearization can be determined from the measurement of a reference curve.

The intensity of the laser light impinging on the detector 33 in turn depends on the distance d by which the recoating face 18 of the recoater blade 16a and the surface 19 of the building platform 12 are spaced apart, i.e. on the size of the gap 31. Thus, the signal generated, i.e. its characteristic value, is also dependent on the distance d.

The signal is then forwarded to the evaluation unit 34 and evaluated by the latter in the fourth step S4, i.e. the distance d between the recoating face 18 of the recoater blade 16a and the surface 19 of the building platform 12 is determined on the basis of the signal.

The distance d is preferably determined by a comparison of the detected signal or its characteristic value with a previously recorded reference measurement curve. FIG. 5a and FIG. 5b show examples of a reference measurement curve 40a, 40b, wherein the signal generated by the detector 33 or the detection unit as a function of the intensity of the laser light incident on the detector 33 is an electrical voltage. FIG. 5a shows the reference measurement curve 40a for a gap width, i.e. a distance d, in the millimeter range (about 0.1 mm to a few millimeters), and the reference measurement curve 40b shown in FIG. 5b is an enlarged section of the reference measurement curve 40a shown in FIG. 5a for a gap width, i.e. a distance d, up to about 100 μm (i.e. up to about 0.1 mm). The gap width, i.e. the distance d, is plotted on the abscissa axis in FIG. 5a and FIG. 5b (in units of μm), and the signal generated by the detector 33 or the detection unit, i.e. the electrical voltage, is plotted on the ordinate axis in FIGS. 5a and 5b (in units of volts). It should be noted that the reference measurement curves shown in FIGS. 5a and 5b are to be understood as purely exemplary representations; an actual behavior of the measurement curves depends on the structural properties and properties in terms of measurement of the elements used and other influencing factors, such as the intensity profile of the laser beam used, the intensity output voltage characteristic of the detector used, etc.

For example, if the signal transmitted to the evaluation unit 34 is a voltage of 4 V, the evaluation unit 34 determines a distance d=500 μm based on the reference measurement curve 40a shown in FIG. 5a. For example, if the signal transmitted to the evaluation unit 34 is a voltage of 0.42 V, the evaluation unit 34 determines a distance d=60 μm based on the reference measurement curve 40b shown in FIG. 5b.

The reference measurement curve 40a of FIG. 5a also shows a limiting voltage UG that is not exceeded even as the distance d increases. This limiting voltage UG indicates the above-mentioned limiting distance above which the laser beam 32 is no longer clipped by the recoater blade.

Here, the reference measurement curve 40a, 40b is provided in advance. It can be generated, for example, by setting a distance d and detecting the respective signal (electrical voltage) generated by the detector 33 or the detection unit. The pairs of the distance d and the associated signal or associated voltage obtained in this way are then plotted in a coordinate system and the data points are interpolated by a suitable function, which is stored as a reference measurement curve. Instead of interpolating discrete data points, it is also possible to perform continuous signal detection with continuously changing, i.e. continuously increasing or continuously decreasing, distance d, and to store the measurement curve generated this way as a reference measurement curve. Alternatively, the distance d can also be determined on the basis of non-interpolated data points, i.e. on the basis of reference measurement values. Instead of the two reference measurement curves 40a, 40b, only one reference measurement curve can also be provided for the entire measurement range.

If the recoating face 18 of the recoater blade 16a and the surface 19 of the building platform 12 are in contact, i.e. there is no gap between the recoater blade 16a and the building platform 12, i.e. the distance d is zero (d=0), then no laser light from the laser beam 32 is incident on the detector 33 either, and the signal or the electrical voltage is substantially zero—provided that an ideal corrector of the offset voltage of the detector 33 has taken place (see also FIGS. 5a, 5b).

Preferably, in the fourth step S4, the evaluation unit 34 subsequently outputs the value of the determined distance d, for example graphically on a monitor of the evaluation unit 34 or a display device and/or storage device provided separately from the evaluation unit 34. Alternatively or in addition, the value of the determined distance d can also be output or transmitted via a data connection, for example a data cable or a wireless connection, such as Bluetooth, to an external device, such as a computer or a smartphone of a user, or to the control unit 29.

In the optional fifth step S5, a position adjustment and/or orientation adjustment of the recoater blade 16a and/or of the building platform 12 is performed. This may be performed manually by a user. Preferably, however, the position adjustment and/or orientation adjustment is performed automatically, for example by the control unit 29 (see FIG. 1). In step S5, for example, the absolute height, i.e. vertical position, of the recoater blade 16a above the building platform 12 or the working plane 7 can be adjusted and/or the absolute height, i.e. vertical position, of the building platform 12 can be adjusted.

Alternatively or in addition to a vertical position adjustment or orientation adjustment, the building platform 12 and/or the recoater blade 16a can also be tilted against each other.

The method for determining the distance d described with reference to FIG. 4 can be further improved by performing the distance measurement not only once but several times, i.e. at least twice. For this purpose, three further developments of the method for determining the distance are described in the following, wherein it is abstained from a repetition of same features and only those features by which the further developments deviate from the embodiment described above are described.

According to a first further development of the invention, the building platform 12 is moved from an initial position in the direction of the recoater blade 16a and, meanwhile, the signal generated by the detector 33 or the detection unit is detected continuously or stepwise in the evaluation unit 34. Here, the initial position can be, for example, a position of the building platform 12 in which the surface 19 of the building platform 12 is below the working plane 7, i.e., in the vertical direction within the container 5 (not shown in FIG. 2). The signal thus detected is initially constant, in the example described above a constant electrical voltage, and decreases as soon as the surface 19 of the building platform 12 reaches the upper edge of the container 5 or the working plane and is moved out of the container 5.

According to a second further development of the invention, the distance d is determined at each of a first location with respect to the longitudinal extension of the recoater blade 16a and at a second location with respect to the longitudinal extension of the recoater blade 16a, the first and second locations being different from one another. In other words, the first location and the second location are spaced apart from each other along the width N of the building platform (see FIG. 6). For this purpose, as shown schematically in the top view of the working plane 7 from above in FIG. 6, a first laser 30a and a second laser 30b, and a first detector 33a and a second detector 33b are provided. The first laser 30a and the first detector 33a, and the second laser 30b and the second detector 33b, are each arranged and aligned to one another analogously to the laser 30 and detector 33b described with reference to FIG. 1 to FIGS. 3, such that the first laser 30a emits a first laser beam 32a that passes at least partially between the recoating face 18 of the recoater blade 16a and the surface 19 of the building platform 12 and impinges on the first detector 33a, and the second laser 30b emits a second laser beam 32b that passes at least partially between the recoating face 18 of the recoater blade 16a and the surface 19 of the building platform 12 and impinges on the second detector 33b. The first detector 33a and the second detector 33b or their detection units can be connected to a common evaluation unit 34 (not shown in FIG. 6) or to two separate evaluation units (not shown in FIG. 6) for evaluating the signal.

The first laser 30a and the second laser 30b are spaced apart from each other by an amount fin the longitudinal direction of the recoater blade 16a, i.e., along the width N of the building platform 12. Similarly, the first detector 33a and the second detector 33b are spaced apart from each other by an amount fin the longitudinal direction of the recoater blade 16a, i.e., along the width N of the building platform 12. The first laser beam 32a and the second laser beam 32b are thus also spaced apart from each other by the amount fin the longitudinal direction of the recoater blade 16a, i.e., along the width N of the building platform 12, so that the locations at which a distance determination is performed by the first laser detector pair 30a, 33a and the second laser detector pair 30b, 33b, respectively, are spaced apart from each other by the amount fin the longitudinal direction of the recoater blade 16a.

With the arrangement shown in FIG. 6, it is possible, for example, to detect and, if necessary, correct relative tilting of the recoating face 18 of the recoater blade 16a and the surface 19 of the building platform 12 with respect to each other.

As an alternative to the arrangement with two laser detector pairs shown in FIG. 6, a distance determination at two different locations spaced apart from each other in the longitudinal direction of the recoater blade 16a can also be carried out using a single laser detector pair (as shown in FIG. 3) by moving each of the laser and the detector parallel to each other along the width N of the building platform 12. For this purpose, the laser and the detector can be attached, for example, to a suitable linear guide, such as a carriage attached to a rail. Alternatively or in addition, more than two laser detector pairs can be provided along the width N of the building platform. With these two alternative embodiments, it is also possible, for example, to perform the distance d at more than two locations spaced apart from each other along the longitudinal direction of the recoater blade 16a.

According to a second further embodiment of the invention, the distance d is determined at each of a first location with respect to the travelling position of the recoater blade 16a along the recoating direction H and at a second location with respect to the travelling position of the recoater blade 16a along the recoating direction H, the first and second locations being different from one another. This is shown schematically in FIG. 7: At a first point of time, the recoater blade 16a is brought to a first travelling position, which is shown in FIG. 7 with a solid line, and the distance d is determined in the first travelling position. Then, by moving in the recoating direction H by an amount g (travel distance), the recoater blade 16a is brought to a second travelling position at a second point of time, which is shown with a dashed line in FIG. 7, and the distance d is determined in the second travelling position. The first and second travelling positions of the recoater blade 16a, and thus also the first and second locations at which the distance d is determined, are spaced apart from one another by the amount g in the recoating direction H. The distance determination can also be carried out at more than two mutually different travelling positions of the recoater blade 16a, up to a continuous distance measurement during the travel of the recoater blade 16a in recoating direction H.

This also makes it possible, for example, to detect and, if necessary, to correct relative tilting of the recoating face 18 of the recoater blade 16a and the surface 19 of the building platform 12 with respect to one another.

The features of the further developments described above can be combined with each other, as far as possible.

FIG. 2 shows a recoating element formed as a flat blade 16a having a planar recoating face 18 substantially parallel to the build area, wherein the recoating face 18 forms the bottom side of the recoater blade and thus the boundary of the recoater blade 16a facing the building platform 12. The recoating element can also be formed as a recoater blade having a different geometric shape, such as a roof blade having two recoating faces converging obliquely, or a radius blade having a rounded recoating face. The boundary of the recoating element facing the building platform 12 can then be a lower edge of the roof blade or radius blade. The recoating element can also be designed as a flexible spreader element, for example a rubber lip and/or brush, or designed as a dimensionally stable spreader element, for example a blade, and/or designed as a recoating roller.

In the above-described method for distance determination, the distance d between the surface 19 of the building platform 12 and the boundary of the recoating element facing the building platform 12, i.e. the recoating face 18, is determined. Alternatively, in the method described above, a distance between the base plate 11, i.e. the surface of the base plate 11 facing the recoating element, and the boundary of the recoating element facing the base plate 11 can also be determined. For this purpose, for example, no building platform 12 is attached onto the base plate 11. In general, in the above-described method for distance determination, a distance is determined between a building base or the surface facing the recoating element and a boundary of the recoating element facing the building base.

On the building base, i.e. the building platform 12 or the base plate 11, there can be a manufactured three-dimensional object and/or residues or remnants of a three-dimensional object produced in a previous building process on the building base and/or residues or remnants of a support structure produced in a previous building process on the building base for supporting an object to be produced. In this case, a distance between the object and/or the residues or remnants of the object and/or of the support structure and the boundary of the recoating element facing the building base can be determined by the method described above. Generally, in the method described above, a distance between the boundary of the recoating element facing the building base and an article placed on the building base can alternatively be determined. The article placed on the building base can also be, for example, a production-related unevenness of the building base itself.

If the building base, i.e. the building platform or base plate, is positioned completely in the container 5 so that it does not protrude beyond the edge of the container in the vertical direction, i.e. the surface of the building base facing the recoating element is positioned below the working plane 7, then it is possible by means of the method described above to determine a distance between the working plane 7 and the boundary of the recoating element facing the building base or the working plane, for example using a reference edge, e.g. the edge of the building container, as an absolute height determined from the relative positioning step. In this way, for example, an absolute height position, i.e. vertical position, of the recoating element in the process chamber 3 can be determined and, if necessary, corrected or adjusted.

Instead of generating a laser beam 32, 32a, 32b using a laser 30, 30a, 30b and detecting the laser beam 32, 32a, 32b using a suitable detector 33, 33a, 33b, which, for example, comprises a number of photodiodes and/or is designed as a CCD sensor and/or CMOS sensor, it is also possible within the scope of the present invention to perform the distance determination using, for example, a number of electron beams which are generated and emitted by an electron beam source and detected by a suitable detector. Generally, the method for determining a distance can be performed using any wave and/or particle beams suitable therefor, i.e. energy beams, wherein at least one suitable beam source is provided for emitting the number of energy beams instead of the laser 30, 30a, 30b, and a suitable detector is provided for detecting a number of the energy beams.

The beam source(s) and/or the detector(s) and, if applicable, the evaluation unit 34 can be provided integrally with the device 1. Alternatively, at least one beam source and/or at least one detector can be provided separately from the device 1. For this purpose, the separately provided beam source and/or the separately provided detector can, for example, include elements for detachable or non-detachable attachment in the process chamber 3 of the device, such as screw connection, magnetic connection, etc. Thus, it is possible to provide at least one beam source and/or at least one detector as an equipment kit or retrofit kit for the device 1.

At least one beam source and at least one detector or at least one detection unit can be provided together with the evaluation unit 34 as a determination device for determining a distance for the device 1, for example as an equipment kit or retrofit kit described above.

An evaluation of the signal generated by the detector or the detection unit can also be performed, for example, by a user or an external device, such as an external computer. In this case, the device 1 can be provided without the evaluation unit 34.

Furthermore, the propagation direction of the laser beam from the respective laser to the respective detector can also be in a direction other than the recoating direction H. For example, the propagation direction of the laser beam can be oblique to the recoating direction.

Although the present invention was described with reference to a laser sintering or laser melting device, it is not limited to laser sintering or laser melting. It can be applied to any method for generatively producing a three-dimensional object by layer-wise application and selective solidification of a building material.

For example, the exposure device can comprise one or more gas or solid state lasers or any other type of laser such as laser diodes, in particular VCSEL (Vertical Cavity Surface Emitting Laser) or VECSEL (Vertical External Cavity Surface Emitting Laser), or a line of such lasers. In general, an exposure device can be any device that can selectively apply energy as wave or particle radiation to a layer of the building material. For example, instead of a laser, another light source, an electron beam, or any other energy or radiation source suitable for solidifying the building material can be used. Instead of deflecting a beam, exposure with a movable row exposure device can also be applied. The invention can also be applied to selective mask sintering, in which an extended light source and a mask are used, or to high-speed sintering (HSS), in which a material that increases (absorption sintering) or decreases (inhibition sintering) radiation absorption at the respective locations is selectively applied to the building material, and then exposed non-selectively over a large area or with a movable row exposure device.

Instead of introducing energy, selective solidification of the applied building material can also be performed by 3D printing, for example by applying an adhesive. In general, the invention relates to additive manufacturing of an object by means of layer-wise application and selective solidification of a building material regardless of the manner in which the building material is solidified.

Various types of powders can be used as a building material, in particular metal powders, plastic powders, ceramic powders, sand, filled or mixed powders. Instead of powder, other suitable materials can also be used as a building material.

1. A method for determining a distance in a device for producing a three-dimensional object by layer-wise selective solidification of a building material in a working plane on a building base, the device comprising at least a recoating element that can be moved in a recoating direction across the working plane for applying a layer of the building material,
the method for determining a distance comprising at least the following steps:
emitting a number of directed beams using a number of beam sources,
detecting at least one of the directed beams from a first beam source using a first detector and generating a signal in dependence on the at least one beam impinging on the least one detector,
wherein the recoating element is spatially arranged between the first beam source and the first detector, and
determining a distance of a boundary of the recoating element facing the building base from the surface of the building base facing the recoating element and/or an article placed on the building base, based on the signal generated by the detector and using an evaluation unit.

2. The method according to claim 1, wherein the distance is determined in a comparison with a predefined reference system a previously recorded reference measurement curve.

3. The method according to claim 1, further comprising a step of a position adjustment and/or orientation adjustment of the recoating element and/or of the building base.

4. The method according to claim 1, wherein the building base is moved from an initial position in the direction of the recoating element, in the process of which the at least one signal is detected continuously or stepwise in the evaluation unit.

5. The method according to claim 1, wherein the distance is determined at a first location with respect to a longitudinal extension of the recoating element using the first beam source and the first detector, and is determined at at least one second location with respect to the longitudinal extension of the recoating element using at least one second beam source and/or at least one second detector, the first and second locations being different from one another.

6. The method according to claim 1, wherein the distance is determined at each of a first location with respect to the travelling position of the recoating element along the recoating direction and at least one second location with respect to the travelling position of the recoating element along the recoating direction, the first and second locations being different from one another.

7. The method according to claim 1, wherein a geometric extension of a beam cross-section of the number of beams perpendicular to their propagation direction is greater than a distance to be determined between the boundary of the recoating element facing the building base and the surface of the building base facing the recoating element or the article placed on the building base.

8. The method according to claim 1, wherein determining the distance is performed on the basis of a predefined reference measurement curve, which is a strictly monotonic function that assigns a value of the distance to each signal generated by the detector.

9. A computer program having program code means for carrying out all steps of a method according to claim 1 when the computer program is executed by means of a data processor cooperating with a device for producing a three-dimensional object by layer-wise selective solidification of a building material.

10. A determination device for determining a distance in a device for producing a three-dimensional object by layer-wise selective solidification of a building material in a working plane on a building base, the device comprising at least a recoating element that can be moved in a recoating direction across the working plane for applying a layer of the building material,
the determination device comprising at least:
a number of beam sources adapted to emit a number of directed beams,
at least a first detector for detecting at least one of the directed beams from a first beam source and generating a signal depending on the beam impinging on the first detector,
an evaluation unit which, in operation, determines a distance between a boundary of the recoating element facing the building base and the surface of the building base facing the recoating element and/or an article placed on the building base, based on the signal generated by the detector, when the recoating element is spatially arranged between the first beam source and the first detector.

11. The determination device according to claim 10, wherein the beam source comprises a laser, the laser light of which is in the visible and/or infrared wavelength range.

12. The determination device according to claim 10, wherein the beam(s) is/are a light beam(s), and a spectral filter is positioned in the propagation direction of the beam(s).

13. A device for producing a three-dimensional object by layer-wise selective solidification of a building material in a working plane on a building base,
the device comprising:
at least a recoating element movable in a recoating direction across the working plane for applying a layer of the building material,
a number of beam sources adapted to emit a number of directed beams,
at least a first detector for detecting at least one of the directed beams from a first beam source and generating a signal depending on the beam impinging on the first detector,
wherein the recoating element is spatially arranged between the first beam source and the first detector,
and wherein the device further comprises an evaluation unit which, in operation, determines a distance between a boundary of the recoating element facing the building base and the surface of the building base facing the recoating element and/or an article placed on the building base, based on the signal generated by the detector.

14. The device according to claim 13, wherein the beam source is arranged in the device such that a propagation direction of the directed beam is substantially parallel to the working plane.

15. The device according to claim 13, wherein the beam source is arranged in the device such that a propagation direction of the directed beam is substantially parallel to the recoating direction.

16. The device according to claim 13, wherein the beam source is arranged in the device such that the directed beam is partially shadowed by the recoating element and/or the building base and/or the article placed on the building base.

17. A method for producing a three-dimensional object on a building base with the steps:
applying a layer of a building material using at least one recoating element that can be moved in a recoating direction across a working plane,
selectively solidifying the applied layer of the building material at points that correspond to the cross-section of the three-dimensional object in the respective layer and
repeating the steps of applying and selectively solidifying until the three-dimensional object is completed,
carrying out a method according to claim 1.
